(19) United States
(12) Patent Application Publication
(10) Pub. No.: US 2003/0196521 A1
(43) Pub. Date: Oct. 23, 2003

(54) Hammer with resilient swivel pivoted joint

(76) Inventor: Tai-Her Yang, Si-Hu Town (TW)

Correspondence Address: RABIN & BERDO, P.C., Suite 500, 1101 14th Street, N.W., Washington, DC, 20005, US

(21) Appl. No.: 10/123,147

(22) Filed: Apr. 17, 2002

(51) Int. Cl. B25D 1/12

(52) U.S. Cl. 81/22

(57) ABSTRACT

A hammer adapted to its head and handle at least with a resilient swivel pivoted joint so to swing with the swivel point as the pivot in the same direction as that of the striking to release the counter force instantaneously generated as the hammer strikes a work piece, so to avoid hurting the user's fingers and limbs.

### BACKGROUND OF THE INVENTION

(a) Field of the Invention

The present invention is related to a hammer adapted with a resilient swivel pivoted joint, and more particularly, to one that is adapted with a resilient swivel pivoted joint that swings with a pivot of the resilient swivel pivoted joint to release a counter force instantaneously created in the direction as the hammer strikes an object, so to avoid possible injury to a user of the hammer.

(b) Description of the Prior Art

A conventional hammer is usually having a handle and a head rigidly incorporated to each other or having a flexible member inserted in a structure where the head and the handle axially penetrate through the structure to be incorporated into each other. In either case, the instantaneous counter force created when the hammer strikes an object will be transmitted back to the handle. As a result, particularly in intensive and heavy strikes, one could easily get his fingers and arm hurt.

### SUMMARY OF THE INVENTION

The primary purpose of the present invention is to provide a hammer adapted at least with a resilient swivel pivoted joint so to swing with the swivel point as the pivot in the same direction as that of the striking to release the counter force instantaneously generated as the hammer strikes a work piece, so to avoid hurting the user's fingers and limbs.

### BRIEF DESCRIPTION OF THE DRAWINGS

FIG. 1 is a view of a first preferred embodiment of the present invention.

FIG. 2 is a sectional view of A-A′ taken from FIG. 1.

FIG. 3 is a view of a resilient swivel pivoted joint taken from FIG. 1 showing an opposite structure.

FIG. 4 is a sectional view of B-B′ taken from FIG. 3.

FIG. 5 is a view of a second preferred embodiment of the present invention.

FIG. 6 is a sectional view of C-C′ taken from FIG. 5.

FIG. 7 is a view of a resilient swivel pivoted joint taken from FIG. 5 showing an opposite structure.

FIG. 8 is a sectional view of D-D′ taken from FIG. 7.

FIG. 9 is a view of a third preferred embodiment of the present invention.

FIG. 10 is a sectional view of E-E′ taken from FIG. 9.

FIG. 11 is a view of a resilient swivel pivoted joint taken from FIG. 9 showing an opposite structure.

FIG. 12 is a sectional view of F-F′ taken from FIG. 11.

FIG. 13 is a view of a fourth preferred embodiment of the present invention.

FIG. 14 is a sectional view of F-F′ taken from FIG. 13.

FIG. 15 is a view of a resilient swivel pivoted joint taken from FIG. 13 showing an opposite structure.

FIG. 16 is a sectional view of G-G′ taken from FIG. 15.

FIG. 17 is a view of a fifth preferred embodiment of the present invention.

FIG. 18 is a sectional view of H-H′ taken from FIG. 17.

FIG. 19 is a view of a sixth preferred embodiment of the present invention.

FIG. 20 is a sectional view of I-I′ taken from FIG. 19.

FIG. 21 is a view of a resilient swivel pivoted joint taken from FIG. 19 showing an opposite structure.

FIG. 22 is a sectional view of J-J′ taken from FIG. 21.

FIG. 23 is a view of a seventh preferred embodiment of the present invention.

FIG. 24 is a sectional view of K-K′ taken from FIG. 23.

FIG. 25 is a view showing that the present invention is incorporated to a handle made of different materials.

FIG. 26 is a sectional view of L-L′ taken from FIG. 25.

FIG. 27 is a view showing where a claw is located to the present invention.

### DETAILED DESCRIPTION OF THE PREFERRED EMBODIMENTS

The present invention of a hammer provided with a resilient swivel pivoted joint is essentially comprised of one or more than one swivel pivoted joint that swings along the direction of the hammer strikes so to release a counter force instantaneously at the time of the striking and said counter force is released in the swinging direction having the swivel pivot as the center, thus to avoid possible injury to one's fingers and limbs.

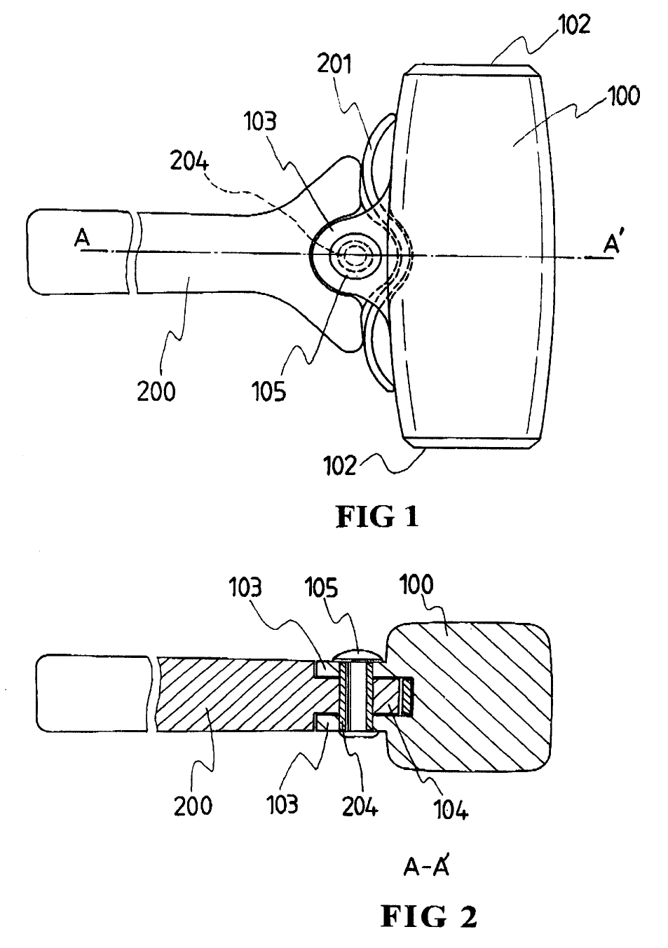

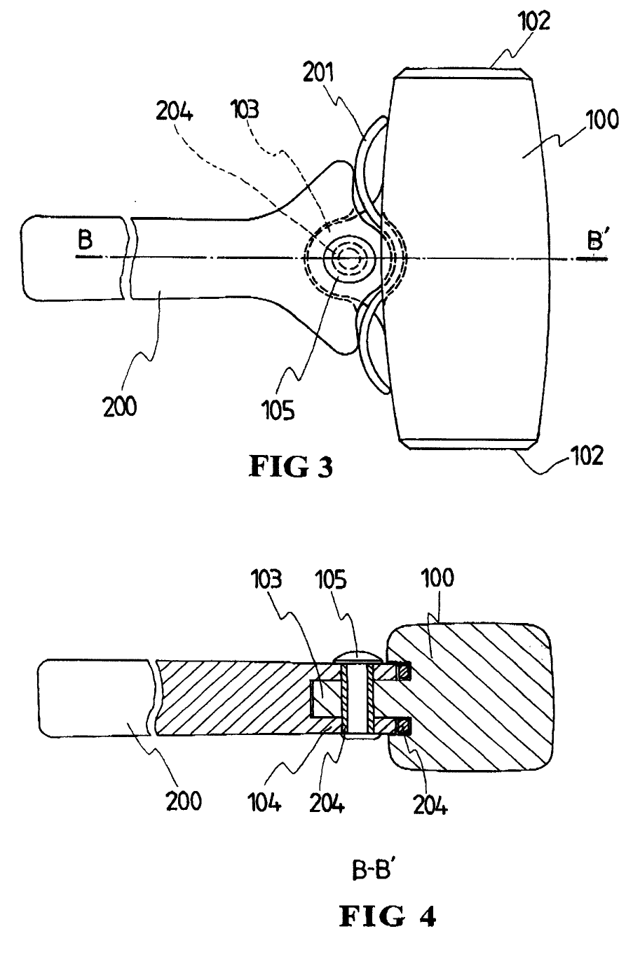

FIG. 1 shows a first preferred embodiment of the present invention; FIG. 2 is a sectional view of A-A′ taken from FIG. 1; is a view of a resilient swivel pivoted joint taken from FIG. 1 showing an opposite structure; and FIG. 4 is a sectional view of B-B′ taken from FIG. 3.

The hammer of the first preferred embodiment of the resilient swivel pivoted joint is essentially comprised of:

a swivel hammerhead structure 100: made of a selected material into an integrated hammerhead depending on its geometric form as required and is characterized by that it further includes two striking ends 102, a pivot 103 and a turning shaft 105; wherein, the turning shaft 105 may be or may not be further inserted with a resilient or flexible member 204 as elected, and the pivot 103 being adapted so to execute angular displacement by swinging along the striking direction when either of said striking ends strikes a work piece;

a handle structure 200 with swivel pivot: made of selected material into an integrated or a combination of multiple parts depending on its geometric form as required and is characterized by that one end of the handle structure 200 with swivel pivot being provided for a user to hold onto it while the other end relates to an output end where adapted with a pivot 104 coupled to the pivot 103 from the swivel hammerhead structure 100; the turning shaft 105 provided to couple to both pivots 103 is attached to the turning shaft 105 either by locking, riveting or caulking and further being inserted with the resilient or flexible member 204 as required so to execute angular displacement between the swivel hammerhead structure 100 and the handle structure 200 with swivel pivot to swing along the striking direction when subject to the striking force;

a flexible limiting member for the pivoted joint angular displacement: being provided at where between the swivel hammerhead structure 100 and the handle structure 200 with swivel pivot to bear and thus to maintain both in stabilized status when they are not subject to striking force; and to cause both to execute flexibly angular displacement when subject to striking force, is comprised of:

1 A curved plate spring or an equivalent coil spring, or laminated spring 201 to function as the flexible limiting member for the pivoted joint angular displacement is disposed between the swivel hammerhead structure 100 and the handle structure 200 with swivel pivot; or

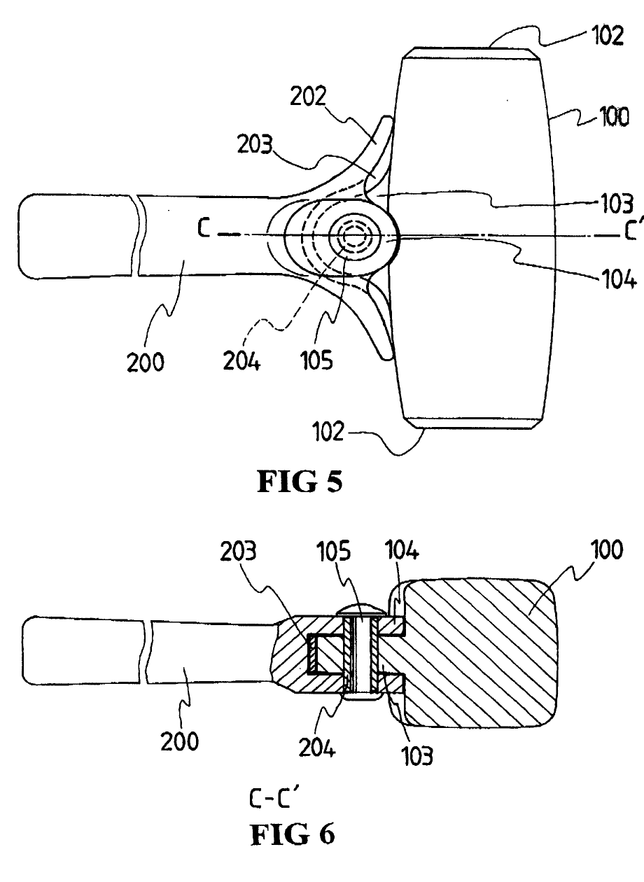

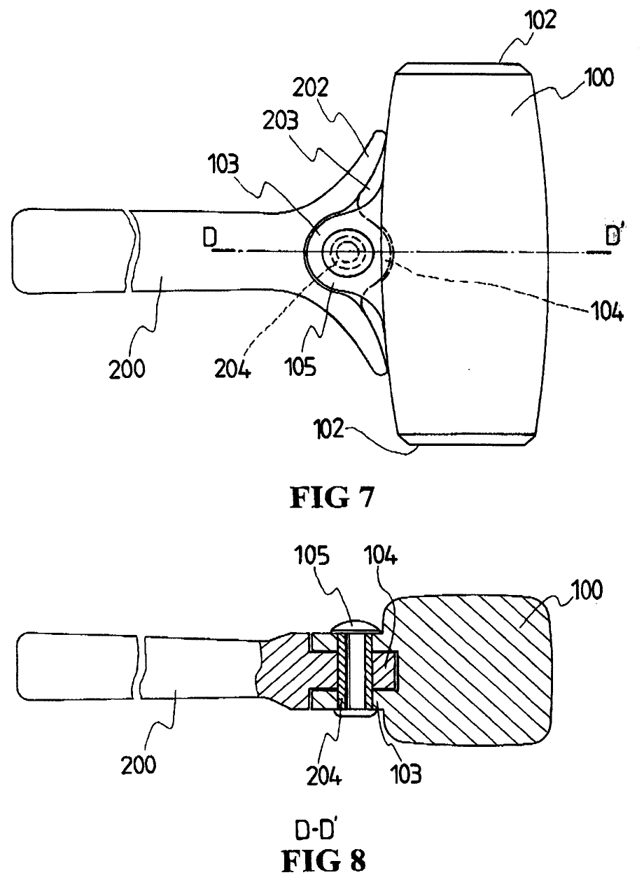

2 As illustrated in FIG. 5 for a second preferred embodiment of the present invention; FIG. 6, a sectional view of C-C′ taken from FIG. 5; FIG. 7, a swivel joint in structure opposite to that in FIG. 5; and FIG. 8, a sectional view D-D′ taken from FIG. 7; either or both of the swivel hammerhead structure 100 and the handle structure 200 with swivel pivot extends towards the striking direction an resilient structure 202 at where between the swivel hammerhead structure 100 and the handle structure 200 with swivel pivot to function as the flexible limiting member for the pivoted joint displacement; or the laminated spring 203 is added between the resilient structure 202 and the swivel hammerhead structure 100 as required;

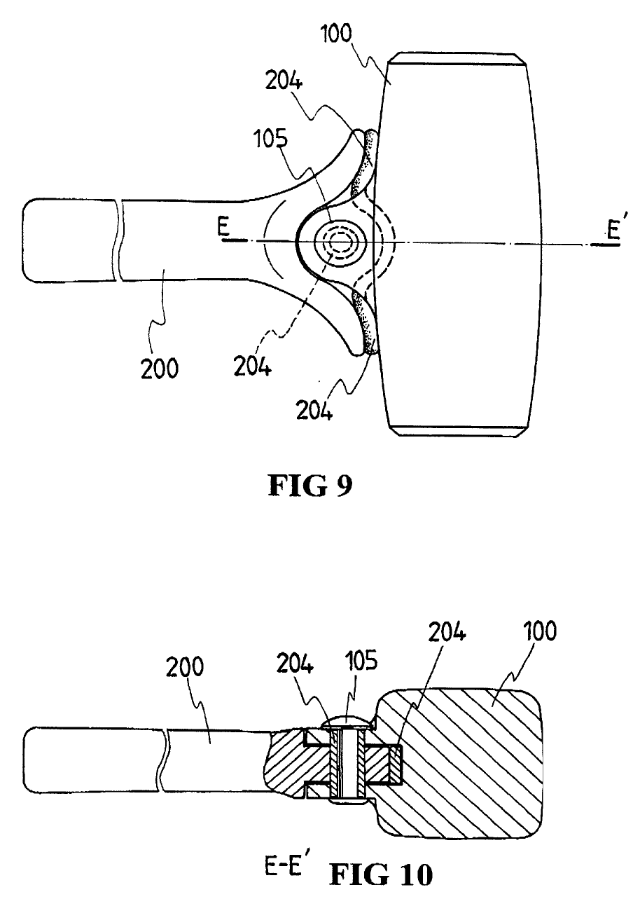

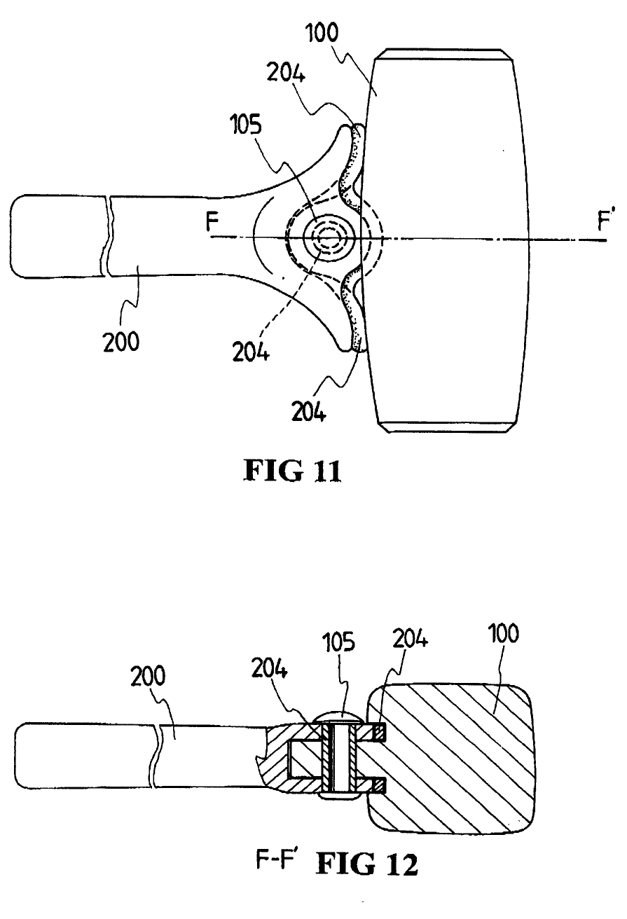

3 As illustrated in FIG. 9 for a third preferred embodiment of the present invention; FIG. 10, a sectional view of E-E′ taken from FIG. 5; FIG. 11, a swivel joint in structure opposite to that in FIG. 10; and FIG. 12, a sectional view F-F′ taken from FIG. 11; a selected resilient or flexible member 204, such as one made of PU or other plastic material or rubber is disposed between the swivel hammerhead structure 100 and the handle structure 200 with swivel pivot to function as the flexible limiting member for the pivoted joint displacement; or

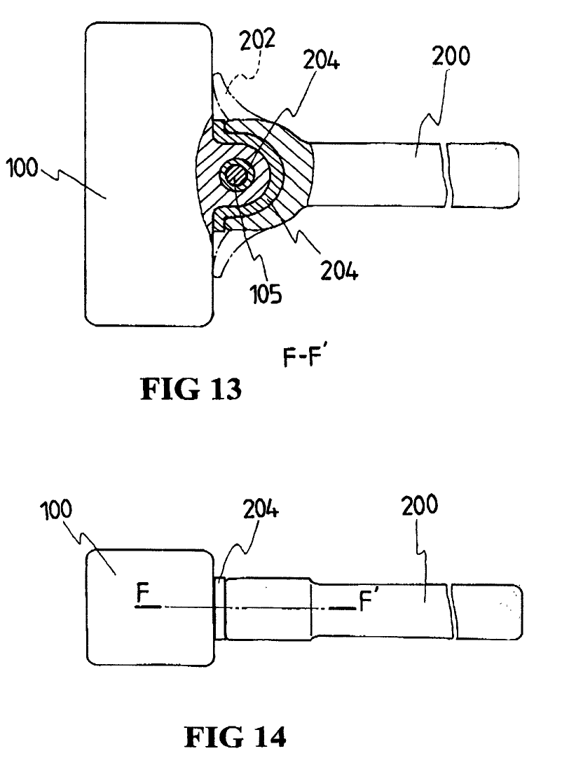

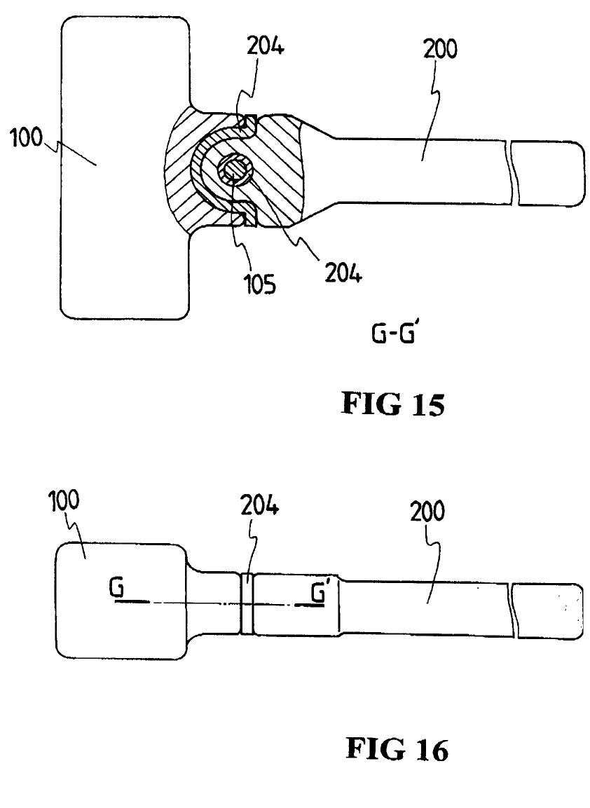

4 As illustrated in FIG. 13 for a fourth preferred embodiment of the present invention; FIG. 14, a sectional view of F-F′ taken from FIG. 13; FIG. 15, a swivel joint in structure opposite to that in FIG. 14; and FIG. 16, a sectional view G-G′ taken from FIG. 15; a space is defined for executing angular displacement along the striking direction by a pivoted structure formed by both pivots and at where between both of the swivel hammerhead structure 100 and the handle structure 200 with swivel pivot to be incorporated to each other, and the resilient structure as disclosed in the preceding subparagraph (1) or (2) or the resilient or flexible member 204 as disclosed in subparagraph (3) is further disposed in the space for executing angular displacement, consequently, the handle structure 200 with swivel pivot is capable of maintaining a stable force application status on the flexibility of the swivel hammerhead structure 100 before the striking; or

5 A spacing or the selected resilient or flexible member 204 such as that made of PU, other plastic or rubber material or structure is disposed between the handle structure 200 with swivel pivot and the swivel hammerhead structure 100 to function as the flexible limiting member for the pivoted joint displacement.

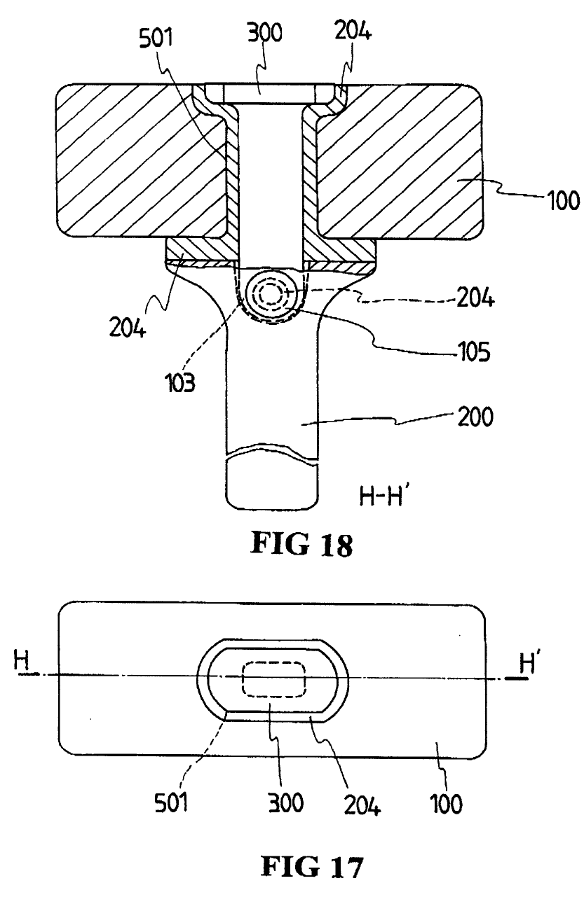

Alternatively, the handle structure 200 with swivel pivot is adapted with a multi-sectional structure as illustrated in FIG. 17 for a fifth preferred embodiment of the present invention; and FIG. 18, a sectional view of H-H′ taken from FIG. 17; wherein, a lateral opening 501 (or a tapered opening) having larger external gradation and smaller internal gradation is provided in the middle section of the swivel hammerhead structure 100 adapted to be inserted with a relay rod 300 having one end capped and the other end a pivot structure; the sectional form of the middle section of the relay rod 300 and the form of the opening 501 of the swivel hammerhead structure 100 relate to square or approximately square, or any other geometric sectional form that allows both of the relay rod 300 and the swivel hammerhead structure 100 when incorporated to each other to be prevent from rotation. The outer diameter of the capped end of the relay rod 300 is greater than the smaller diameter of the lateral opening 501 of the swivel hammerhead structure 100 to prevent falling off while the other end of the relay rod 300 provided with the pivot is coupled to the pivot 103 from the handle structure 200 with swivel pivot by means of the penetrating turning shaft 105. Wherein, the turning shaft 105 may be inserted with the resilient or flexible member 204 as required thus to enable the swivel hammerhead structure 100 to execute angular displacement swinging along the striking direction at where between the swivel hammerhead structure 100 and the handle structure 200 with swivel pivot. A flexible limiting mechanism for the pivoted joint displacement is further adapted between the swivel hammerhead structure 100 and the handle structure 200 with swivel pivot while the flexible limiting member for the pivoted joint displacement is placed at where between the relay rod 300 and the hammerhead including the selected resilient or flexible member 204 made of PU, other plastic material or rubber as disclosed in the preceding subparagraph (3) to function as the flexible limiting member for the pivoted joint displacement; and one or more than one of those flexible limiting members for the pivoted joint displacement as disclosed in the preceding subparagraphs (1), (2), (4) and/or (5) is provided at where between the swivel hammerhead structure 100 and the handle structure 200 with swivel pivot.

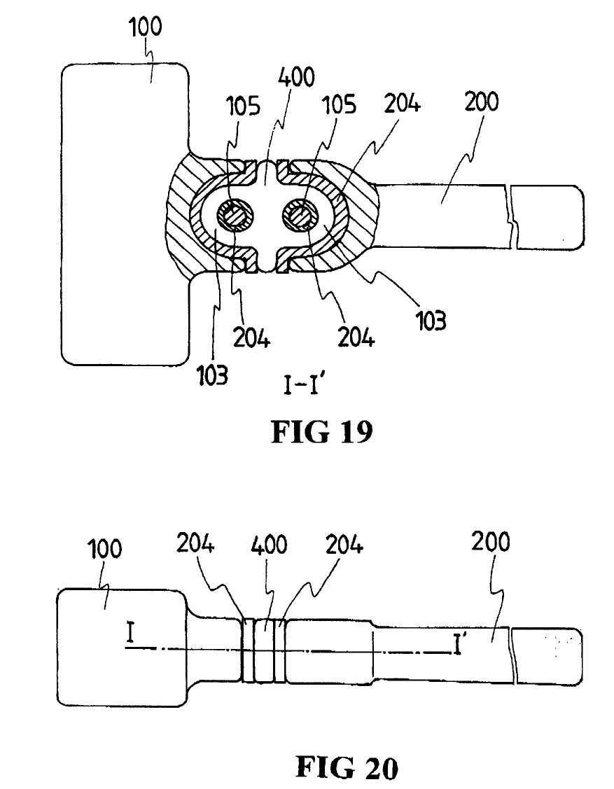

Now referring to FIG. 19 for a sixth preferred embodiment of the present invention and FIG. 20 for a sectional view of I-I′ taken from FIG. 19, the multi-sectional structure of the handle structure 200 with swivel pivot further comprises of an additional relay joint 400 disposed between the swivel hammerhead structure 100 and the handle structure 200 with swivel pivot, and a pivot each respectively provided to both ends of the relay joint 400 to be coupled to the pivot 103 of the swivel hammerhead structure 100 and the pivot of the handle structure 200 with swivel pivot by separately penetrating the turning shaft 105. As required, the turning shaft 105 may or may not be inserted with the resilient or flexible member 204. The middle section of the relay joint 400 extends externally to be coupled to both of the swivel hammerhead structure 100 and the handle structure 200 with swivel pivot so to provide the flexible limiting member for the pivoted joint displacement comprised of one or more than one configuration as disclosed in the preceding subparagraphs (1), (2), (3), (4) and/or (5).

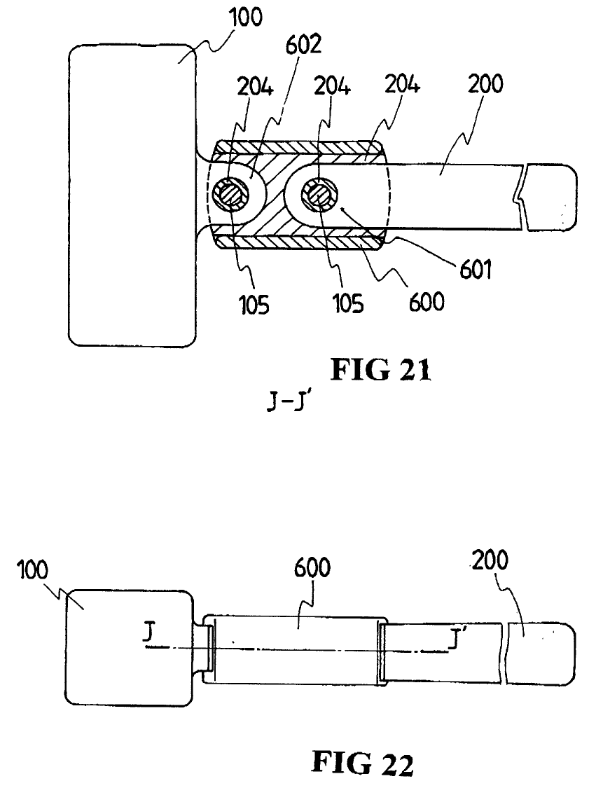

FIG. 21 shows an opposite structure of the swivel joint to that illustrated in FIG. 19 and FIG. 22 is a sectional view of J-J′ taken from FIG. 21. Wherein, the handle structure in multi-sectional structure is further comprised of an additional relay joint 600 adapted between the swivel hammerhead structure 100 and the handle structure 200 with swivel pivot. Both ends of the relay joint 600 are respectively with a pivot structure to be inserted to their corresponding pivot joints 601 and 602 from the handle structure 200 with swivel pivot and the swivel hammerhead structure 100 by penetrating the turning shaft 105. As required, the turning shaft 105 may or may not be inserted with the resilient or flexible member 204, and is comprised of one or more than one configuration as disclosed in the preceding subparagraphs (3), (4) and/or (5).

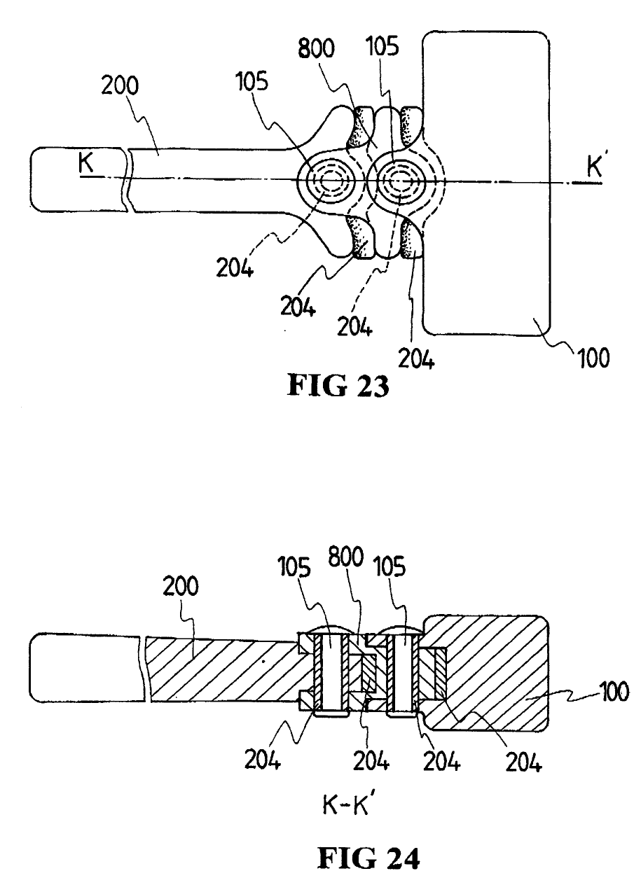

FIG. 23 shows a seventh preferred embodiment of the present invention and FIG. 24 is a sectional view of K-K′ taken from FIG. 23. Wherein, the handle structure in multi-sectional structure is that the preferred embodiment illustrated in FIGS. 9 and 10 further comprised at where between the swivel hammerhead structure 100 and the handle structure 200 with swivel pivot of one or more than one section of a laminated or relay block 800 having respectively provided at its front and rear ends a pivot coupled to their corresponding pivots from the swivel hammerhead structure 100 and the handle structure 200 with swivel pivot by means of the turning shaft 105. The resilient or flexible member 204 is each respectively placed in where between the coupled pivots with their swivel angle that can be limited. As required, the turning shaft 105 may or may not be inserted with the resilient or flexible member 204.

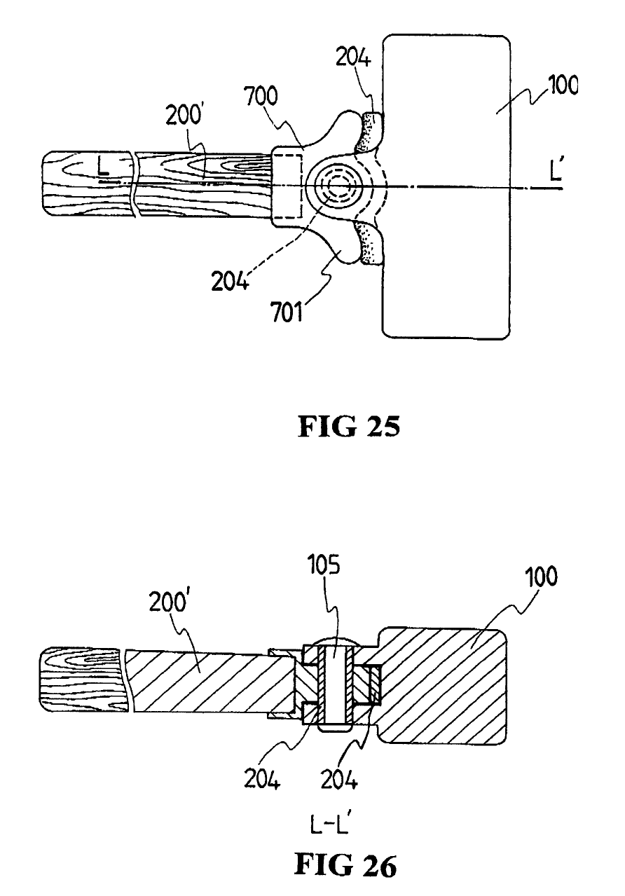

Furthermore, to cope with various application needs, the present invention may be adapted with a handle made of different materials as a preferred embodiment illustrated in FIG. 25. FIG. 26 shows a sectional view of L-L′ taken from FIG. 25. Wherein, one end 200′ for grip of the handle structure 200 with swivel pivot is made of different material while the other end is incorporated to an output section 701 comprised of a pivot structure, then further coupled to the swivel hammerhead structure 100. An opening 700 adapted to be co-axially incorporated to the handle is disposed in the output section 701 comprised of the pivot structure, and the pivot structure 103 is provided to the output section 701 adapted to be coupled each other to the swivel hammerhead structure 100. The coupling between the output section 701 and the swivel hammerhead structure 100 is made by swivel by means of the turning shaft 105, which as required may be or may not be inserted with the resilient or flexible member 204. The handle made of different materials incorporated by means of the opening may be achieved by a packing means or by insertion of a fixed packing, or by taking advantage of adhesion or thermal contraction or other fixing means generally known to the practice of the prior art.

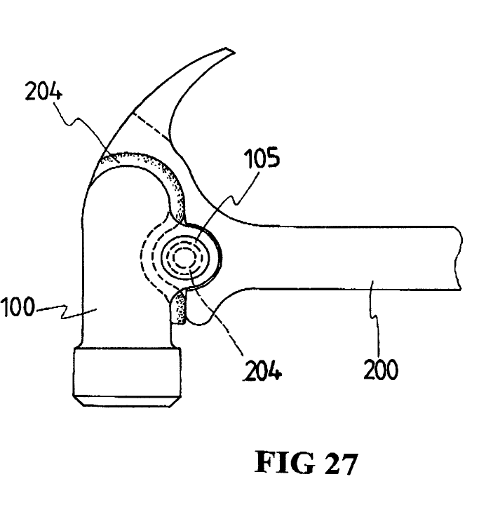

In practice, the form and material for the hammerhead structure may vary depending on the application. A conventional claw may be provided to one end of the hammerhead structure of the present invention, or as illustrated in FIG. 27, wherein, the claw is provided to the handle structure 200 with swivel pivot that is further includes the output section of pivot structure.

As disclosed, a hammer provided with a swivel resilient pivoted joint along its striking direction of the present invention by providing one or more than one swivel pivoted joint in the striking direction of the hammerhead and the handle that swings along the striking direction so to swing in the striking direction with the swivel pivot as the center to release the counter force instantaneously generated upon the hammer strikes a work object and thus to prevent injuries to fingers and limbs of a user of the hammer, is innovative in concept and providing its specific functions. Therefore, this application is duly filed accordingly.

1. A hammer with a resilient swivel pivoted joint essentially comprised of one or more than one swivel pivoted joint that swings along the direction of the hammer strikes so to release a counter force instantaneously at the time of the striking and said counter force is released in the swinging direction having the swivel pivot as the center.

2. A hammer with a resilient swivel pivoted joint hat swings in the striking direction as claimed in claim 1 further comprising:
a swivel hammerhead structure 100: made of a selected material into an integrated hammerhead depending on its geometric form as required and is characterized by that it further includes two striking ends 102, a pivot 103 and a turning shaft 105; wherein, the turning shaft 105 may be or may not be further inserted with a resilient or flexible member 204 as elected, and the pivot 103 being adapted so to execute angular displacement by swinging along the striking direction when either of said striking ends strikes a work piece;
a handle structure 200 with swivel pivot: made of selected material into an integrated or a combination of multiple parts depending on its geometric form as required and is characterized by that one end of the handle structure 200 with swivel pivot being provided for a user to hold onto it while the other end relates to an output end where adapted with a pivot 104 coupled to the pivot 103 from the swivel hammerhead structure 100; the turning shaft 105 provided to couple to both pivots 103 is attached to the turning shaft 105 either by locking, riveting or caulking and further being inserted with the resilient or flexible member 204 as required so to execute angular displacement between the swivel hammerhead structure 100 and the handle structure 200 with swivel pivot to swing along the striking direction when subject to the striking force; and
a flexible limiting member for the pivoted joint angular displacement: being provided at where between the swivel hammerhead structure 100 and the handle structure 200 with swivel pivot to bear and thus to maintain both in stabilized status when they are not subject to striking force; and to cause both to execute flexibly angular displacement when subject to striking force.

3. A hammer with a resilient swivel pivoted joint that swings in the striking direction as claimed in claim 2, wherein, the flexible limiting member for the pivoted joint includes a curved plate spring or an equivalent coil spring, or laminated spring 201 to function as the flexible limiting member for the pivoted joint angular displacement is disposed between the swivel hammerhead structure 100 and the handle structure 200 with swivel pivot.

4. A hammer with a resilient swivel pivoted joint that swings in the striking direction as claimed in claim 2, wherein, the flexible limiting member for the pivoted joint includes that either or both of the swivel hammerhead structure 100 and the handle structure 200 with swivel pivot extends towards the striking direction an resilient structure 202 at where between the swivel hammerhead structure 100 and the handle structure 200 with swivel pivot to function as the flexible limiting member for the pivoted joint displacement; or the laminated spring 203 is added between the resilient structure 202 and the swivel hammerhead structure 100 as required.

5. A hammer with a resilient swivel pivoted joint that swings in the striking direction as claimed in claim 2, wherein, the flexible limiting member for the pivoted joint includes a selected resilient or flexible member 204, such as one made of PU or other plastic material or rubber is disposed between the swivel hammerhead structure 100 and the handle structure 200 with swivel pivot to function as the flexible limiting member for the pivoted joint displacement.

6. A hammer with a resilient swivel pivoted joint that swings in the striking direction as claimed in claim 2, wherein, the flexible limiting member for the pivoted joint includes a space is defined for executing angular displacement along the striking direction by a pivoted structure formed by both pivots and at where between both of the swivel hammerhead structure 100 and the handle structure 200 with swivel pivot to be incorporated to each other, and the resilient or flexible member 204 adapted in the space for executing angular displacement for the handle structure 200 with swivel pivot to maintain a stable force application status on the flexibility of the swivel hammerhead structure 100 before the striking.

7. A hammer with a resilient swivel pivoted joint that swings in the striking direction as claimed in claim 2, wherein, the flexible limiting member for the pivoted joint includes a spacing or the selected resilient or flexible member 204 such as that made of PU, other plastic or rubber material or structure is disposed between the handle structure 200 with swivel pivot and the swivel hammerhead structure 100 to function as the flexible limiting member for the pivoted joint displacement.

8. A hammer with a resilient swivel pivoted joint that swings in the striking direction as claimed in claim 1, further comprising a lateral opening 501 (or a tapered opening) having larger external gradation and smaller internal gradation provided in the middle section of the swivel hammerhead structure 100; and a relay rod 300 having one end capped and the other end a pivot structure; the sectional form of the middle section of the relay rod 300 and the form of the opening 501 of the swivel hammerhead structure 100 indicating square or approximately square, or any other geometric sectional form that allows both of the relay rod 300 and the swivel hammerhead structure 100 when incorporated to each other to be prevented from rotation; the outer diameter of the capped end of the relay rod 300 being made greater than the smaller diameter of the lateral opening 501 of the swivel hammerhead structure 100 to prevent falling off while the other end of the relay rod 300 provided with the pivot being coupled to the pivot 103 from the handle structure 200 with swivel pivot by means of the penetrating turning shaft 105; the turning shaft 105 may be inserted with the resilient or flexible member 204 as required thus to enable the swivel hammerhead structure 100 to execute angular displacement swinging along the striking direction at where between the swivel hammerhead structure 100 and the handle structure 200 with swivel pivot; a flexible limiting mechanism for the pivoted joint displacement further adapted between the swivel hammerhead structure 100 and the handle structure 200 with swivel pivot while the flexible limiting member for the pivoted joint displacement being placed at where between the relay rod 300 and the hammerhead including the selected resilient or flexible member 204 made of PU, other plastic material or rubber to function as the flexible limiting member for the pivoted joint displacement; and one or more than one of those flexible limiting members for the pivoted joint displacement being provided at where between the swivel hammerhead structure 100 and the handle structure 200 with swivel pivot.

9. A hammer with a resilient swivel pivoted joint that swings in the striking direction as claimed in claim 1, another yet of the multi-sectional structure of the handle structure 200 with swivel pivot further comprises of an additional relay joint 400 disposed between the swivel hammerhead structure 100 and the handle structure 200 with swivel pivot, and a pivot each respectively provided to both ends of the relay joint 400 to be coupled to the pivot 103 of the swivel hammerhead structure 100 and the pivot of the handle structure 200 with swivel pivot by separately penetrating the turning shaft 105; as required, the turning shaft 105 may or may not be inserted with the resilient or flexible member 204; the middle section of the relay joint 400 extending externally to be coupled to both of the swivel hammerhead structure 100 and the handle structure 200 with swivel pivot so to provide the flexible limiting member for the pivoted joint displacement comprised of one or more than one configuration as disclosed above.

10. A hammer with a resilient swivel pivoted joint that swings in the striking direction as claimed in claim 1, wherein, the handle structure in multi-sectional structure is further comprised of an additional relay joint 600 adapted between the swivel hammerhead structure 100 and the handle structure 200 with swivel pivot; both ends of the relay joint 600 being respectively with a pivot structure to be inserted to their corresponding pivot joints 601 and 602 from the handle structure 200 with swivel pivot and the swivel hammerhead structure 100 by penetrating the turning shaft 105 as required, the turning shaft 105 may or may not be inserted with the resilient or flexible member 204, and is comprised of one or more than one configuration as disclosed above.

11. A hammer with a resilient swivel pivoted joint that swings in the striking direction as claimed in claim 1, wherein, the flexible limiting member for the pivoted joint includes the handle structure in multi-sectional structure being further yet comprised at where between the swivel hammerhead structure 100 and the handle structure 200 with swivel pivot of one or more than one section of a laminated or relay block 800 having respectively provided at its front and rear ends a pivot coupled to their corresponding pivots from the swivel hammerhead structure 100 and the handle structure 200 with swivel pivot by means of the turning shaft 105; the resilient or flexible member 204 being each respectively placed in where between the coupled pivots with their swivel angle that can be limited; as required, the turning shaft 105 may or may not be inserted with the resilient or flexible member 204.

12. A hammer with a resilient swivel pivoted joint that swings in the striking direction as claimed in claim 1, wherein, one end 200′ for grip of the handle structure 200 with swivel pivot is made of different material while the other end is incorporated to an output section 701 comprised of a pivot structure, then further coupled to the swivel hammerhead structure 100; an opening 700 adapted to be co-axially incorporated to the handle being disposed in the output section 701 comprised of the pivot structure, and the pivot structure 103 is provided to the output section 701 adapted to be coupled each other to the swivel hammerhead structure 100; the coupling between the output section 701 and the swivel hammerhead structure 100 is made by swivel by means of the turning shaft 105, which as required may be or may not be inserted with the resilient or flexible member 204; and the handle made of different materials incorporated by means of the opening may be achieved by a packing means or by insertion of a fixed packing, or by taking advantage of adhesion or thermal contraction or other fixing means generally known to the practice of the prior art.

13. A hammer with a resilient swivel pivoted joint that swings in the striking direction as claimed in claim 1, wherein, a conventional claw maybe provided to one end of the hammerhead structure of the present invention, or to the handle structure 200 with swivel pivot that is further includes the output section of pivot structure.
